(19) United States
(12) Patent Application Publication
(10) Pub. No.: US 2004/0022342 A1
(43) Pub. Date: Feb. 5, 2004

(54) Method of incineration of minor actinides in nuclear reactors

(76) Inventors: Joseph Magill, Karlsruhe (DE); Paolo Peerani, Caravate (IT)

Correspondence Address: NATH & ASSOCIATES, 1030 15th STREET, 6TH FLOOR, WASHINGTON, DC, 20005, US

(21) Appl. No.: 10/257,575

(22) PCT Filed: Apr. 23, 2001
(86) PCT No.: PCT/EP01/04573

(30) Foreign Application Priority Data
Apr. 26, 2000 (LU) 90 570

(51) Int. Cl. G21G 1/00

(52) U.S. Cl. 376/156

(57) ABSTRACT

A method of incineration of minor actinides in nuclear reactors is presented. The minor actinides to be incinerated are embedded in at least one finite region of a core of a thermal nuclear reactor. This finite region is isolated from the rest of the core by means of a thin layer of material that absorbs thermal neutrons but is transparent to fast neutrons. This isolating material is preferably fissile, so that the neutron flux in the core is not simply filtered of its thermal neutrons, but also amplified in its fast neutrons.

### FIELD OF THE INVENTION

The present invention relates to a method of incineration of minor actinides in nuclear reactors.

### BACKGROUND OF THE INVENTION

The expression “minor actinides” (MA) is used herein to refer mainly to the elements neptunium, americium and curium, which are produced as radioactive by-products in nuclear reactors, wherein the term “minor” refers to the fact that these elements are produced in smaller quantities in comparison to the “major” actinide plutonium.

The disposal of increasing quantities of highly radio-toxic minor actinides, which are undesirable by-products in the nuclear fuel cycle, is a major problem to be solved in order to guarantee a future for the nuclear industry.

Presently, transmutation of minor actinides in nuclear rectors (also called herein incineration) is thought to be the most interesting and effective method for reducing their radio-toxicity. However, there is no agreement among the scientists about the best scenario for a cycle with an optimal efficiency in the transmutation of minor actinides. What is clear is that thermal nuclear reactors, i.e. reactors in which most of the neutrons reach thermal equilibrium with the atoms of the reactor at energies of a few hundredths of an electron volt, do a priori not provide adequate conditions for incineration purposes. The most promising options for the incineration of minor actinides are reactors with fast neutron fluxes, in particular liquid metal fast breeder reactors or accelerator driven subcritical systems. However, in the foreseeable future there will still be a shortage of fast flux nuclear reactors for incinerating growing amounts of minor actinides.

### OBJECT OF THE INVENTION

The technical problem underlying the present invention is to provide an alternative solution to fast breeder reactors or accelerator driven subcritical systems for the incineration of minor actinides. This problem is solved by a method as claimed in claim 1.

### SUMMARY OF THE INVENTION

In accordance with the present invention the minor actinides to be incinerated, are embedded in at least one finite region of a core of a thermal reactor, wherein the finite region is isolated from the rest of the core by means of a barrier layer that absorbs thermal neutrons but is transparent to fast neutrons.

It will be noted that the mean free path of neutrons in a material is generally much shorter for thermal neutrons than for fast neutrons. For instance, in highly enriched metal uranium the mean free path is of the order of 0.3 mm for thermal neutrons and 10 cm for fast neutrons. It follows that a barrier layer having a thickness that is bigger than the mean free path of thermal neutrons but shorter than the mean free path of fast neutrons, will absorb most thermal neutrons, but is practically transparent to fast neutrons. Thus, a thin layer of an adequate material can be used to form a kind of “high-band neutron filter” around a finite region in the core of the thermal reactor wherein the minor actinides to be incinerated are embedded. In practice, the thickness of such a “high-band neutron filter” is e.g. at least three times the mean free path of thermal neutrons and advantageously in the range of six to ten times the mean free path of thermal neutrons.

Moreover, if the barrier layer comprises mainly a fissile material, then the absorbed thermal neutrons will not be lost but will produce new fast neutrons by fission. It follows that in the barrier layer, the neutron flux is not simply filtered of its thermal neutrons, but also amplified in its fast neutrons. In the ideal case (no parasitic capture, 100% fission efficiency) v fast neutrons are produced per incident thermal neutron in the barrier layer. In summary, it is advantageously made use of the neutron flux converter capability of a thin fissile layer to generate within the core of a thermal reactor at least one isolated region with fast neutron fluxes. Provided that no moderating material is present inside such an isolated region, the neutron flux will be prevalently fast therein, thus allowing an effective incineration of minor actinides in the core of a thermal reactor. Such an isolated region in the core of the thermal reactor can be qualified as “a fast island”.

The barrier layer can consist of one single layer of fissile material or comprise two or more such layers separated by a non-fissile material, preferably a heavy metal with low neutron capture and good thermal conductivity, such as e.g. lead.

The ratio of the minor actinide mass embedded in the finite region enclosed by the barrier layer to the fissile mass in the barrier layer is advantageously in the range of two to four.

The fissile material to be used in the barrier layer is preferably chosen from the group comprising: U-235; Pu-238; Pu-239 ; Pu-240; Pu-241 ; Pu-242; reactor-grade and weapon-grade Pu and Am-242m. If Am-242m is to be used, the barrier layer can be initially made of or loaded with Am-241, which transmutes partially into Am-242m in the neutron flux of the core.

Within a fast island, the minor actinides are preferably embedded in a matrix consisting of a heavy element with low neutron capture, as e.g. lead. They may e.g. be homogeneously dispersed in the matrix.

If the thermal reactor comprises pin-type fuel elements in the core, then the minor actinides are advantageously embedded in at least one pin-type MA element having substantially the same outer form and dimension as the pin-type fuel elements, so that it can replace such a fuel element. In a first embodiment, the barrier layer of such an element consists of a single thin layer of fissile material having a thickness between 1 and 3 mm. Alternatively, several pin-type MA elements can be arranged in parallel and be isolated from the rest of the core by means of a common barrier layer.

A pin-type MA element can also comprise a barrier layer with two or more concentric layers of fissile material, which are separated from each other by a non-fissile intermediate material of good thermal conductivity and low neutron capture.

The thermal reactor may for example be a pressurised-water-reactor, but high-temperature-gas-cooled-reactors (HGTR) may offer even better conditions for incinerating minor actinides in fast islands. Indeed, in a HGTR the moderator (graphite) and the coolant (gas) are distinct. It follows that heat can be easily removed from the fast island by the reactor coolant, without thereby causing any significant neutron moderation in the fast island.

If the reactor is e.g. a pebble bed high-temperature-gas-cooled-reactor, then it is of advantage to homogeneously disperse the minor actinides in a matrix and to form pebbles thereof, wherein these pebbles are then coated with a thin barrier layer of fissile material. The diameter of the MA pebbles will be chosen so as to obtain a reasonable ratio between the fissile mass in the thin barrier layer and the minor actinides mass loaded in the pebble.

Finally, providing fast islands in future bloc type high-temperature-gas-cooled-reactors seems to be a promising solution too. To be incinerated in such a reactor, the minor actinides can e.g. be homogeneously dispersed in a matrix and formed to a prismatic bloc that has substantially the same outer shape and dimensions as a fuel bloc in such a reactor. This MA bloc is then provided with a thin barrier layer of fissile material. It will be appreciated that this solution enables—when compared to the pebble bed solution—to provide a more advantageous ratio of the fissile material mass in the thin barrier layer and the minor actinides mass loaded in the bloc.

### BRIEF DESCRIPTION OF THE DRAWINGS

The invention will now be illustrated by some examples, wherein it will be referred to the accompanying drawings, in which;

FIG. 1: is a diagram comparing the spectra generated for three different thicknesses of a thin fissile layer;

FIG. 2: is a diagram comparing the spectra generated for three films of different fissile materials having the same thickness (1 mm).

### DETAILED DESCRIPTION OF SOME EXAMPLES

Reference Composition of Minor Actinides

The composition of minor actinides (MA) in spent nuclear fuels depends on many factors, such as the reactor type, the initial composition of the fresh fuel and the burnup. Moreover several scenarios for fuel cycle and waste management can be considered. The once-through cycle assumes UO₂ fuel to be used just once in thermal reactors and the spent fuel to be treated as waste. In a single-recycle option the spent fuel is reprocessed to recover U and Pu for the fabrication of MOX fuels to be used in thermal reactors. Multiple-recycle options consider the possibility of further reprocessing cycles to feed fast reactors or accelerator driven systems.

All these different scenarios lead to different compositions of the final waste. So when performing a study about the incineration of minor actinides, a choice about the reference scenario that determines the isotopic composition of the minor actinides in the waste must be made. For illustrating the present invention, the single-recycle option and the corresponding waste management have been retained. Table 1 reports the annual MA production of a MOX fuelled PWR (3 GWth).

The composition shown in this table 1 will be used as reference composition hereinafter. Of course, different scenarios could generate completely different compositions. It can however be reasonably assumed that the validity of the present calculations is not strongly dependent on the MA composition. Numerical results could change a little with a different composition, but not the general conclusions.

TABLE 1
Annual MA production in a MOX fuelled PWR

| Isotope | Production (kg/y) | % |
|---|---|---|
| Np-237 | 4.8 | 3.0 |
| Am-241 | 87.8 | 55.7 |
| Am-242 m | 0.9 | 0.6 |
| Am-243 | 44.3 | 28.1 |
| Cm-243 | 0.2 | 0.1 |
| Cm-244 | 19.6 | 12.4 |
| Total | 157.7 | 100 |

Choice of the Fissile Material for the Thin Layer

In accordance with the invention, a thin layer of fissile material is used as a flux converter to separate the fast island from the thermal reactor.

The basic condition to be fulfilled is that the thickness of the thin layer should be greater than the mean free path of thermal neutron in the fissile material. At least three mean free paths are a minimum requirement, but a factor six to ten is preferable.

In principle any fissile material could be used. The most common materials are enriched uranium, weapon-grade and reactor-grade plutonium.

Am-242m is an interesting candidate because of its very high fission cross-sections that allow extremely thin layers of the order of the micrometer. Unfortunately its is difficult to produce Am-242m and separate it from other americium isotopes. To overcome this problem, it is suggested to produce Am-242m on site. This can e.g. be done by coating the fast island with pure Am-241, which is easily available by separation from reprocessed plutonium. Am-241 will then capture neutrons and produce Am-242m. After a short time the Am-242m content will grow and stabilise to an equilibrium value. In a pressurised-water-reactor (PWR) the estimated build-up time is of the order of two months and the equilibrium ratio Am-242m/Am-241 is 5.4%. In an high-temperature-gas-cooled-reactor (HTGR) the required build-up time is shorter but the equilibrium value is lower (1.4%).

Table 2 lists the thermal capture and fission cross-sections and the mean free path of thermal neutrons for some possible fissile materials. In the calculation of the mean free path the density of the metal was retained. For oxides the value should be roughly double.

TABLE 2
Thermal cross-sections and mean free path for fissile materials

| Fissile | Thermal cross-sections (barn) | | | Mean free |
|---|---|---|---|---|
| material | fission | capture | absorption | path (μm) |
| U-235 | 582 | 99 | 681 | 302 |
| Pu-238 | 17 | 547 | 564 | 354 |
| Pu-239 | 743 | 269 | 1012 | 198 |
| Pu-240 | 0.03 | 290 | 290 | 695 |
| Pu-241 | 1010 | 368 | 1378 | 147 |
| Pu-242 | 0.2 | 18.5 | 18.7 | 10850 |
| R-grade Pu | 578 | 280 | 857 | 234 |
| Am-241 | 3 | 832 | 835 | 252 |
| Am-242m | 6600 | 1400 | 8000 | 26 |
| Am-eq (5.4%) | 359 | 863 | 1222 | 172 |
| Am-eq (1.6%) | 95 | 840 | 935 | 225 |

The values of Table 2 show that there are no fundamental differences between the listed fissile materials. More or less all of them have the same properties. The weapon-grade plutonium is slightly better. Highly enriched uranium and reactor-grade plutonium are practically equivalent. Equilibrium americium has a shorter mean free path but a less favourable distribution between fission and capture. It will be noted that for all these materials, the fissile layer thickness ranges from one to a few millimetres.

Choice of the Matrix

Any moderating material should be avoided inside the fast island to prevent neutron thermalisation. So the choice of suitable matrix materials will be limited to medium and heavy elements. Other important characteristics are required for the matrix material: good chemical compatibility with minor actinides, low neutron capture, good mechanical and thermal properties.

It will be appreciated that the definition of the matrix material is not a key issue of the present invention. For the present calculations, lead has been chosen as a representative of a heavy element with good neutronic properties. Lead is of course not an optimal choice, since it melts at a rather low temperature and does not have very good mechanical properties.

Scheme of the Analysis and Limitations

The feasibility of fast islands in PWR and HTGR reactors is demonstrated by way of performance calculations.

In each case, the calculations are carried out in accordance with the following scheme:

first, a reference calculation for the ordinary fuel is performed, including calculation of the k-infinity of fuel, k-effective of an isolated fuel element (both for fresh and half-burnt fuel composition), k-effective and flux distribution in the reactor;

a preliminary simplified design of the MA assembly is fixed, trying to comply with the basic constraint that this MA assembly should have the same geometry and reactivity of a normal (fresh) fuel element;

a reactor model comprising a fast island surrounded by ordinary fuel is developed, and the spectrum distribution in the fast island is calculated;

finally, with the spectral indices derived in the previous step, the cross-sections in the fast island can be obtained, and the evolution of the composition in the fast island and the incineration rate can be computed.

To preserve the fast neutron flux in the fast islands, no light elements can enter therein. It follows that in case the incineration takes place in a PWR, the inside of the fast island cannot be cooled by the reactor coolant, i.e. light water. For a HTGR the cooling situation of the fast islands is much more favourable. Indeed, cooling gas with its low density has no moderation effect. Consequently, if the MA elements in the HGTR have the same geometry and reactivity of the standard fuel elements used in the HTGR, the thermo-hydraulic conditions will not be substantially changed by the presence of the fast islands,

Calculation Methodology

Calculations are done using the SCALE modular system (version 4.4).

This system was developed at Oak Ridge National Laboratory (ORNL) for the Nuclear Regulatory Commission (NRC) to provide a tool for a standardised method of analysis for the evaluation of fuel facility and transport design. It can perform criticality, shielding and heat transport evaluations.

It is a modular system; i.e. it comprises a collection of computer codes, each one performing a specific task. These computer codes can be interconnected thanks to a standardised compatibility of the input/output files. The single codes can be sequentially linked to for calculation sequences defined by the user. The system also provides some pre-defined sequences, called procedures, that allow to generate with a simple condensed input some code sequences required for the most common tasks like e.g. shielding analysis, spent fuel characterisation or criticality analysis.

The main modules used in the following examples are:

BONAMI, which retrieves multi-group cross-sections and performs a preliminary calculation of the self-shielding for all the nuclides based on a simplified zero-dimensional method (Bondarenko method);

NITAWL, which computes the self-shielding factors for the main resonant nuclides using the Nordheim integral method which takes into account the 1-D pin geometry;

XSDRNPM, which solves the Boltzmann equation of neutron transport in the 1-D cell geometry, computing the space-energy distribution of neutron flux, then computes the cell k-effective and eventually condenses the cross-sections;

COUPLE, which updates ORIGEN libraries with the cross-sections and spectral parameters computed by XSDRNPM, creating problem and burnup dependent libraries;

ORIGEN-S, which computes the isotopic evolution of fuel composition;

KENO, which is a 3-D Montecarlo code to compute k-effective and neutron flux distribution in complex geometry.

Most calculations are done using the sequences provided in SCALE:

CSAS1X executes BONAMI and NITAWL for cross-section treatment and then XSDRNPM to compute the k-effective in simple geometry;

CSAS2X adds to the same sequence of CSAS1X the execution of KENO to allow the treatment of three-dimensional geometry;

SAS2H is the typical iterative sequence used to perform burnup analyses: the series BONAMI-NITAWL-XSDRNPM is repeated at each time step to create condensed cross-sections specific of the cell geometry and fuel composition as a function of burnup, then ORIGEN computes the time evolution of fuel.

CSAS1X is used for the calculation of the k-infinite of the various compositions; CSAS2X for the analysis both of the assembly and of the reactor models to compute the k-effective and neutron spectra; SAS2H for the fuel composition evolution and in the analysis of the minor actinide incineration.

Two different cross-section libraries are used: the 27-group library from ENDF/B-IV and the 238-group from ENDF/B-V. The 27-group library is mainly used to reduce computing time in the PWR calculations (there are no significant differences with those obtained with the larger library). For HTGR calculations the more reliable 238-group library must be used, as much larger discrepancies have been noticed between the two libraries.

Calculation Results

1. Pressurised-Water Reactor (PWR)

a) Reference Calculations

As a reference configuration of a typical PWR reactor, a 1000 MWe reactor fuelled with 3.2% enriched uranium has been retained. The elementary cell is composed by a UO₂ pellet with a diameter of 0.91 cm, cladded with a 0.07 cm thick Zircalloy and cooled with water. The fuel assembly geometry is a 15×15 square lattice of pins with a pitch of 1.43 cm and an overall cross dimension of 21.5 cm. The reactor core is a cylinder with a 320 cm diameter and 360 cm height.

The basic results are summarised in Table 3, giving for a fresh fuel element and for a half-burned composition: the k-infinity of fuel, the k-effective of a bare single assembly and the k-effective of the reactor supposed to be entirely filled with identically burnt fuel. The fact that the reactor k-effective for the half-burnt composition is very close to one confirms the good modelling of the problem. To define the half-burnt composition, a final burnup of 33000 MWd/t has been assumed.

Table 4 gives the composition of the fresh and half-burnt fuel.

Fifteen fission products have been explicitly included: Xe-135, Tc-99, Rh-103, Xe-131, Cs-133, Nd-143, Nd-145, Pm-147, Sm-149, Sm-150, Sm-151, Sm-152, Eu-153, Eu-155 and Gd-157. They account for the majority of the neutron absorption

TABLE 3
Summary of k values for reference PWR calculations

| | Fresh fuel | Half-burnt comp. |
|---|---|---|
| k-inf fuel | 1.215 | 1.028 |
| k-eff single assembly | 0.273 | 0.235 |
| k-eff reactor | 1.191 | 1.010 |

TABLE 4
Fuel compositions used in the calculations

| | Fresh fuel | Half-burnt comp. |
|---|---|---|
| Uranium/Initial heavy metal | 100% | 98% |
| U-235/U | 3.2% | 2% |
| U-238/U | 96.8% | 98% |
| Plutonium/Initial heavy metal | — | 0.4% |
| Pu-239/Pu | — | 65% |
| Pu-240/Pu | — | 20% |
| Pu-241/Pu | — | 12% |
| Pu-242/Pu | — | 3% |
| FP/Initial heavy metal | — | 1.6% |

b) Homogeneous MA Assembly Design

A configuration wherein the minor actinides are homogeneously dispersed in a lead the matrix is assumed.

The reference geometry for an MA element in a PWR is a block of a mixture MA-matrix having the same overall dimensions as a normal fuel element, i.e. roughly a block with a length of 3 m having a square section of 20×20 cm². To simplify the calculation geometry, the fuel element has been modelled as a cylinder with a 20 cm diameter, but this will not affect the results.

First of all it has been tried to estimate a reasonable content of MA in the mixture by requiring that the k-infinity of the mixture would be similar to the k-infinity of fresh fuel. Results reported in Table 5 show that this condition is met with a volume fraction of MA in the range of 10%, corresponding to a total amount of the order of 200 kg of MA in the assembly.

For an identical assembly geometry, the condition of equal k-infinity implies that the k-effective of the assembly is similar as well. This assures that the presence of the special assembly will not affect the overall reactivity of the reactor. Of course local effects are to be expected due to the impact of the different composition on the neutron spectrum, but it can be reasonably assumed that the introduction of the special assembly should not have dramatic consequences on the reactor performances.

TABLE 5
Reactivity of the MA mixture as a function of volume fraction

| Vol. fract. of MA | Mass of MA | k-inf mixture | k-eff assembly |
|---|---|---|---|
| 0.2 | 430 | 1.410 | 0.514 |
| 0.1 | 215 | 1.207 | 0.296 |

The presence of the coating with a thin fissile layer slightly increases the reactivity of the MA assembly (see Table 6 for the different possible fissile materials). This increase could be partially compensated by reducing the volume fraction of MA in the mixture, but this reduction must not be pushed too far, because the mass ratio fissile/MA should be kept as low as possible.

TABLE 6
MA assemblies with different fissile layer coatings

| Volume | MA mass | Coating | Coating | Fissile | k-eff |
|---|---|---|---|---|---|
| fract. MA | (kg) | material | thick. (mm) | mass (kg) | assembly |
| 0.1 | 215 | None | 0 | 0 | 0.296 |
| 0.1 | 215 | U-235 | 1 | 43 | 0.310 |
| 0.1 | 215 | U-235 | 2 | 87 | 0.325 |
| 0.1 | 215 | Rg-Pu | 1 | 45 | 0.317 |
| 0.1 | 215 | Rg-Pu | 2 | 91 | 0.344 |
| 0.1 | 215 | Am-eq | 1 | 45 | 0.311 |
| 0.1 | 215 | Am-eq | 2 | 91 | 0.331 |

As shown in Table 6, all three fissile materials considered (i.e. highly enriched uranium, reactor grade plutonium and equilibrium americium) have similar effect on the assembly reactivity.

The effect of the fissile layer in the spectrum hardening inside the fast island is shown in FIGS. 1 and 2. The neutron spectra have been computed by using the CSAS2X sequence of SCALE. In all the 3-D calculations a full PWR reactor with half-burned composition was represented and a fast island composed by a single MA homogeneous assembly was placed at the centre of the core. In all cases the k-effective of the reactor was not perturbed by the presence of the fast island.

FIG. 1 compares the spectra generated by layers of HEU of respectively 1, 2 and 3 mm thickness. FIG. 2 compares layers of different fissile materials (HEU, Rg-Pu and Am) having the same thickness (1 mm). In both figures the unperturbed flux of the PWR is shown as a reference.

Some spectral data for the analysed cases are reported in table 7: relative thermal, epithermal and fast fluxes and advantage factors (ratio between fast flux in the fast island and in the PWR reactor).

TABLE 7
Spectral indices in the computed cases

| | | | | Advantage |
|---|---|---|---|---|
| Case | Thermal flux | Epith. Flux | Fast flux | factor |
| PWR | 2.01E−07 | 6.07E−07 | 7.25E−07 | 1.0 |
| MA-HEU-3mm | 7.09E−10 | 1.19E−06 | 4.15E−06 | 5.7 |
| MA-HEU-2mm | 6.71E−10 | 9.43E−07 | 3.22E−06 | 4.4 |
| MA-HEU-1mm | 1.28E−09 | 6.84E−07 | 2.10E−06 | 2.9 |
| MA-Pu-1mm | 3.49E−10 | 7.61E−07 | 2.32E−06 | 3.2 |
| MA-Am-1mm | 4.21E−10 | 4.82E−07 | 1.47E−06 | 2.0 |

The optimization of the layer thickness is a complex problem involving several parameters and a detailed treatment of this aspect goes beyond the purposes of the present description. Some major conclusions can be noted anyway. Increasing the thickness of the layer will improve the conversion of thermal neutrons into fast ones. A layer thinner than 1 mm will be quite ineffective. On the other hand the ratio of fissile mass per unit of MA mass should be minimised, since it would not be justified to invest too much valuable fissile material to burn waste. Since the fission of a fissile atom will produce between two and three neutrons that can be used to fission the same number of MA atoms (there will be losses due to capture and leakage but as well gain due to self-multiplication in the MA), it can be expected that a MA/fissile ratio in the range of two to four should be reasonable. This turns out to be reached with a thickness between 1 and 2 mm. A larger thickness would result in an unjustified high amount of fissile in the coating.

In so far as the choice of the material is concerned, we can conclude that there are no substantial differences between the considered materials, just a slight preference for reactor grade plutonium and HEU with respect to Am.

c) Heterogeneous MA Assembly

In a heterogeneous assembly the MA and the matrix are physically separated. As a reference configuration of a heterogeneous assembly a lattice of cylindrical rods of metallic MA coated with fissile layer inside a lead matrix has been chosen.

As a starting point, rods with a diameter of 1.8 cm have been considered. This choice has been induced by the fact that with a 2 mm thick layer the MA/fissile ratio is 2, and that this condition has proved to be optimal in the homogeneous case.

Calculations have shown that the requirement to reproduce the same reactivity of a fresh fuel element is met when a single MA rod is loaded in the heterogeneous assembly. Under this condition just 16 kg of MA (coated with 8 kg of fissile material) can be hosted in each assembly. Therefore a much higher number of special assemblies have to be loaded in the reactor.

Moreover from the point of view of the spectrum hardening, this heterogeneous MA assembly proves to be less efficient than the homogeneous MA assembly.

d) MA Incineration

The evolution of fuel and MA composition in the reactor and in the fast island have been computed with ORIGEN-S. Starting from the basic card-image 3-group library for LWR, problem dependant 1-group data have been produced by assigning suitable values to the three spectral indices THERM, RES and FAST defined in the ORIGEN manual. The spectral indices for the PWR fuel have been taken from an average of the values produced by a three-cycle SAS2 calculation. Those for the MA assembly burnt in the fast islands have been computed by integrating over three groups the spectra shown in the previous section and multiplying the PWR indices for the ratios of the group integrated spectra. The case of a MA homogeneous assembly coated with 2 mm of HEUm has been analysed. Spectral indices and total fluxes are shown in Table 8.

TABLE 8
Spectral indexes and total fluxes for ORIGEN calculations

| | THERM | RES | FAST | Total flux |
|---|---|---|---|---|
| PWR core | 0.517 | 0.338 | 2.674 | 3.56E+13 |
| Fast island | 0.0017 | 0.525 | 11.89 | 9.67E+13 |

Table 9 resumes the results of the ORIGEN calculations. The initial amount is based on the composition reported in Table 1. Due to the lack of information about the irradiation time that could be tolerated by the special assembly, the material was supposed to be irradiated for three years, that is the normal irradiation time of ordinary fuel. The third column of Table 9 reports the final MA composition if irradiated in the reactor core, and the fourth column shows the final MA composition after irradiation in the fast island.

It can be seen that only 27% of the MA would be incinerated in the thermal reactor after three years, whereas 55% would be burnt in the fast island. The incineration rate in the fast island is roughly the double of that in the thermal reactor.

TABLE 9
MA incineration (kg) in a PWR

| Nuclide | Initial amount | Reactor core | Fast island |
|---|---|---|---|
| U234 | 0.00E+00 | 3.67E+02 | 2.18E+02 |
| U235 | 0.00E+00 | 8.98E+01 | 2.34E+02 |
| U236 | 0.00E+00 | 7.63E+00 | 3.93E+01 |
| NP237 | 4.84E+03 | 1.74E+03 | 1.63E+02 |
| PU238 | 0.00E+03 | 3.15E+04 | 3.14E+04 |
| PU239 | 0.00E+00 | 7.40E+03 | 9.67E+03 |
| PU240 | 0.00E+00 | 3.47E+03 | 7.24E+02 |
| PU241 | 0.00E+00 | 1.69E+03 | 1.76E+03 |
| PU242 | 0.00E+00 | 5.18E+03 | 2.81E+02 |
| AM241 | 8.78E+04 | 2.29E+03 | 2.87E+01 |
| AM242M | 9.20E+02 | 1.22E+02 | 1.17E+01 |
| AM243 | 4.43E+04 | 1.28E+04 | 5.26E+02 |
| CM242 | 0.00E+00 | 3.95E+03 | 8.87E+02 |
| CM243 | 2.30E+02 | 4.46E+02 | 1.19E+02 |
| CM244 | 1.96E+04 | 3.55E+04 | 8.08E+03 |
| CM245 | 0.00E+00 | 4.87E+03 | 1.00E+04 |
| CM246 | 0.00E+00 | 2.42E+03 | 5.65E+03 |
| CM247 | 0.00E+00 | 7.74E+01 | 3.96E+02 |
| CM248 | 0.00E+00 | 1.38E+01 | 3.04E+02 |
| TOTAL | 1.58E+05 | 1.15E+05 | 7.14E+04 |
| U | 0.00E+00 | 4.64E+02 | 4.91E+02 |
| NP | 4.84E+03 | 1.74E+03 | 1.63E+02 |
| PU | 0.00E+00 | 4.92E+04 | 4.38E+04 |
| AM | 1.33E+05 | 1.52E+04 | 5.66E+02 |
| CM | 1.98E+04 | 4.73E+04 | 2.54E+04 |
| Trans-Cm | | | 3.50E+02 |

2. Pebble Bed High-Temperature-Gas-Cooled-Reactor

a) Reference Calculations

As a representative of a typical pebble bed HTGR reactor, the German THTR reactor has been chosen. This is a prototype 300 MWe helium cooled reactor. The fuel elements are graphite spheres with 3 cm radius. The core of the fuel element is filled with micro-spheres (roughly 1 mm sized) of oxide fuel coated with alternate layers of pyrolitic carbon and silicon carbide. The normal fuel is a mixture of thorium oxide and highly enriched uranium oxide. The reactor core is partially loaded with fuel elements as well as with fertile elements containing just thorium oxide. The overall dimensions of the core are 6 m height and 5.6 m diameter.

The basic results of the reference calculations are summarised in Table 10, giving for a fresh fuel element and for a half-burned composition: the k-infinity of fuel, the k-effective of a bare single assembly and the k-effective of the reactor supposed to be entirely filled with identically burnt fuel. The fact that the reactor k-effective for the half-burnt composition is very close to 1 confirms the good modelling of the problem.

Table 11 gives the composition of the fresh and half-burnt fuel. To estimate the half-burnt composition it has been assumed a final burnup of 100000 MWd/t of the fuel at discharge and accounted the same 15 fission products of the PWR case.

Unlike the PWR case where the k-eff of the reactor in the half-burnt condition was very close to unity (as it should be), here the k-eff is slightly too high (1.1). This is probably due to fact that the presence of fertile fuel elements cannot be represented, since the calculation model allows a single type of fuel elements and so the reactor is loaded with 100% of more reactive fuel elements.

TABLE 10
Summary of k values for reference pebble bed
HTGR calculations

| | Fresh fuel | Half-burnt comp. |
|---|---|---|
| k-inf fuel | 1.435 | 1.190 |
| k-eff single assembly | 0.0005 | — |
| k-eff reactor | 1.352 | 1.107 |

TABLE 11
Fuel compositions used in the calculations

| | Fresh fuel | Half-burnt comp. |
|---|---|---|
| Thorium/Initial heavy metal | 90% | 88.5% |
| Uranium/Initial heavy metal | 10% | 6.5% |
| U-223/U | — | 22% |
| U-234/U | — | 2% |
| U-235/U | 93% | 54% |
| U-236/U | — | 13% |
| U-238/U | 7% | 9% |
| FP/Initial heavy metal | — | 5% |

b) MA Assembly Design

The MA assembly has been assumed to be a sphere with the same diameter of fuel assembly (6 cm). No graphite is present, the composition being a homogeneous mixture of MA and matrix A heterogeneous arrangement with microspheres similar to the fuel element could also be considered. The fissile coating is on the surface of the sphere. A further coating with some structural material will be required, but it has not been considered at this stage.

With this arrangement it will be impossible to have the same reactivity of the normal fuel element. In fact, normal fuel elements are loaded with roughly 11 grams of mixed oxide, of which nearly 1 g is HEU. In the MA assembly, even with the hypothesis of a coating with the minimum thickness of 1 mm, this would result in 200 g of HEU. That would give a reactivity much higher than normal fuel elements, even without any contribution from the MA.

For instance a sphere loaded with a mixture having 10% of volume fraction of MA (corresponding to nearly 200g), coated with 1 mm of HEU has a k-eff of 0.076.

It will be noted that the overall reactivity of the reactor will not be affected by the presence of a limited number of MA assemblies, but local power peaking must of course be taken into consideration.

FIG. 3 shows the spectra of neutron fluxes in the ordinary fuel element and in the fast island in the case of a coating of 1 mm HEU. The flux improvement in the fast region is much higher than in the PWR case, due to the fact that the HTGR spectrum is softer. Advantage factors of the order of 10 can easily be reached.

c) MA Incineration

The same calculation procedure described above has been applied to compute the evolution of fuel and MA composition in the reactor and in the fast island. The case of a MA spherical assembly coated with 1 mm of HEU has been retained. Spectral indices and total fluxes are shown in Table 12.

TABLE 12
Spectral indices and total fluxes for ORIGEN calculations

| | THERM | RES | FAST | Total flux |
|---|---|---|---|---|
| HTGR fuel | 0.498 | 0.058 | 0.142 | 2.80E+14 |
| Fast island | 0.044 | 0.123 | 1.200 | 7.67E+14 |

Table 13 resumes the results of the ORIGEN calculations. To simplify the comparison, also in this case the MA assembly is supposed to be submitted to the same irradiation history than an ordinary fuel element.

In HTGR, only 50% of the MA would be incinerated in a normal assembly, even after the high burnup to which these are subjected confirming the low efficiency of this kind of reactor for incineration purposes. In the fast island, nearly 75% of MA would be burnt in the same irradiation conditions.

TABLE 13
MA incineration (kg) in a pebble bed HTGR

| Nuclide | Initial amount | Reactor core | Fast island |
|---|---|---|---|
| U234 | 0.00E+00 | 7.46E+01 | 6.39E+01 |
| U235 | 0.00E+00 | 1.95E+01 | 7.22E+01 |
| U236 | 0.00E+00 | 6.87E+00 | 1.74E+01 |
| NP237 | 4.84E+03 | 5.10E+02 | 2.21E+01 |
| PU238 | 0.00E+00 | 6.23E+03 | 1.42E+04 |
| PU239 | 0.00E+00 | 1.17E+03 | 3.45E+03 |
| PU240 | 0.00E+00 | 1.70E+03 | 3.89E+02 |
| PU241 | 0.00E+00 | 9.74E+02 | 1.56E+03 |
| PU242 | 0.00E+00 | 7.08E+03 | 6.39E+02 |
| AM241 | 8.78E+04 | 4.20E+02 | 6.01E+02 |
| AM242M | 9.20E+02 | 5.97E+00 | 2.14E+01 |
| AM243 | 4.43E+04 | 9.21E+03 | 7.15E+02 |
| CM242 | 0.00E+00 | 5.45E+03 | 3.97E+03 |
| CM243 | 2.30E+02 | 2.80E+02 | 3.36E+02 |
| CM244 | 1.96E+04 | 3.86E+04 | 5.58E+03 |
| CM245 | 0.00E+00 | 1.26E+03 | 2.63E+03 |
| CM246 | 0.00E+00 | 3.38E+03 | 6.72E+03 |
| CM247 | 0.00E+00 | 9.26E+01 | 4.99E+02 |
| CM248 | 0.00E+00 | 2.99E+01 | 5.94E+02 |
| TOTAL | 1.58E+05 | 7.74E+04 | 4.29E+04 |
| U | 0.00E+00 | 1.01E+02 | 1.54E+02 |
| NP | 4.84E+03 | 5.10E+02 | 2.21E+01 |
| PU | 0.00E+00 | 1.72E+04 | 2.02E+04 |
| AM | 1.33E+05 | 9.64E+03 | 1.34E+03 |
| CM | 1.98E+04 | 4.91E+04 | 2.03E+04 |

1. A method of incineration of minor actinides in nuclear reactors characterised in that said minor actinides are embedded in at least one finite region of a core of a thermal nuclear reactor, wherein said finite region is isolated from the rest of the core by means of a barrier layer that absorbs thermal neutrons but is transparent to fast neutrons.

2. The method as claimed in claim 1, characterised in that the thickness of the barrier layer is lager than the mean free path of thermal neutrons, but smaller than the mean free path of fast neutrons.

3. The method as claimed in claim 2, characterised in that the thickness of the barrier layer is in the range of three to ten times the mean free path of thermal neutrons.

4. The method as claimed in any one of claims 1 to 3, characterised in that the barrier layer comprises mainly fissile material.

5. The method as claimed in claim 4, characterised in that said fissile material is chosen from the group comprising; U-235; Pu-238; Pu-239; Pu-240; Pu-241 ; Pu-242; reactor-grade Pu; weapon-grade Pu; Am-242m.

6. The method as claimed in claim 5, characterised in that the barrier layer is originally made of or loaded with Am-241, which transmutes partially into Am-242m in the neutron flux of the core.

7. The method as claimed in any one of claims 1 to 6, characterised in that said finite region is substantially free from any moderating material.

8. The method as claimed in any one of claims 1 to 7, characterised in that said minor actinides are embedded in a matrix consisting of a heavy metal with low neutron capture.

9. The method as claimed in claim 8, characterised in that said minor actinides are homogeneously dispersed in said matrix.

10. The method as claimed in claim 8, characterised in that said minor actinides and said matrix form a heterogeneous assembly in which said minor actinides and said matrix are physically separated.

11. The method as claimed claim in any one of claims 1 to 10, characterised in that
said core comprises pin-type fuel elements,
said minor actinides are embedded in at least one pin-type MA element having substantially the same outer form and dimensions as said pin-type fuel elements; and
said pin-type MA element has said barrier layer thereon.

12. The method as claimed in claim 11, characterised in that said barrier layer consists of a layer of fissile material with a thickness between 1 and 3 mm.

13. The method as claimed in any one of claims 1 to 12, characterised in that said thermal reactor is a pressurised-water-reactor.

14. The method as claimed in any one of claims 1 to 10, characterised in that said thermal reactor is a high-temperature-gas-cooled-reactor.

15. The method as claimed in claim 14, characterised in that said thermal reactor is pebble bed high-temperature-gas-cooled-reactor.

16. The method as claimed in claim 15, characterised in that said minor actinides are homogeneously dispersed in a matrix and conditioned under the form of pebbles, wherein these pebbles are coated with a thin layer of fissile material.

17. The method as claimed in claim 14, characterised in that said thermal reactor is a bloc type high-temperature-gas-cooled-reactor.

18. The method as claimed in claim 17, characterised in that said minor actinides are homogeneously dispersed in a matrix and formed to a prismatic MA bloc that has substantially the same outer shape and dimensions as a fuel bloc, wherein this MA bloc is provided with said barrier layer.
